(19) United States
(12) Patent Application Publication
(10) Pub. No.: US 2008/0188614 A1
(43) Pub. Date: Aug. 7, 2008

(54) Process For Producing Silicone Compositions Comprising Finely Divided Fillers

(75) Inventors: Christof Woerner, Burghausen (DE); Frank Achenbach, Simbach am Inn (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/914,253

(22) PCT Filed: May 11, 2006
(86) PCT No.: PCT/EP2006/004451

§ 371 Date: Nov. 13, 2007

(30) Foreign Application Priority Data
May 20, 2005 (DE) 10 2005 023 403.8

(51) Int. Cl. C08L 83/04

(52) U.S. Cl. 524/588

(57) ABSTRACT

The invention relates to a process for producing mixtures which contain a finely divided, surface-treated filler, silicones and, if appropriate, further additives, and which can be used for producing crosslinkable silicone rubber compositions, wherein the crosslinkable silicone rubber compositions produced from the filler/silicone mixtures produced have excellent viscosity stability, improved processability, and lead to silicone elastomers having an improved property profile.

The invention relates to a process for producing mixtures which comprise a finely divided, surface-treated filler, silicones and, if appropriate, further additives and can be used for producing crosslinkable silicone rubber compositions, which process has the advantage that the crosslinkable silicone rubber compositions produced from the filler/silicone mixture produced according to the invention have excellent viscosity stability and improved processability and lead to silicone elastomers having an improved property profile.

The production of crosslinkable silicone rubber compositions, which are well known under the names HTV, LSR and RTV, comprises as necessary process step the mixing of polyorganosiloxanes (silicones) with fillers, in particular finely divided, reinforcing fillers having a specific surface area of at least 50 m²/g, to give the silicone elastomers produced therefrom sufficient mechanical strength and elasticity. Preferred reinforcing fillers are pyrogenic or precipitated silicas and carbon blacks. Polyorganosiloxanes and fillers are usually firstly mixed to give a base mixture which is subsequently completed by mixing in further constituents such as crosslinkers, catalysts, stabilizers, plasticizers, pigments, etc., to give the crosslinkable silicone rubber composition. Numerous methods of producing these base mixtures, i.e. for dispersing finely divided fillers and silicones, are known. A distinction can basically be made between two process variants which are employed according to the hydrophobic or hydrophilic character of the filler to be dispersed. The particularly preferred finely divided silicas are initially obtained, as a result of the method of production, as hydrophilic particles which greatly restricts their direct use for producing crosslinkable silicone compositions because the strong interactions with the polyorganosiloxanes due to the hydrophilic character of the silica lead to a drastic increase in viscosity (crepe hardening right up to brittleness), as a result of which further processing of the crosslinkable silicone composition is made difficult or prevented entirely. For this reason, it is absolutely necessary to hydrophobicize the silica in order to obtain viscosity-stable, in particular flowable, silicone compositions.

The hydrophobicization of the silica can be carried out in a separate process step, as described in the German published specification DE 38 39 900 A1. The hydrophobic silica can then be dispersed in the polyorganosiloxane in continuously or discontinuously operating mixing apparatuses. A further process variant for producing base mixtures is described in the German published specification DE 25 35 334 A1. In this variant, the hydrophilic silica is mixed into the polyorganosiloxane in the presence of water and a hydrophobicizing agent such as hexamethyldisilazane (in-situ process). In both process variants, a hydrophobic silica is ultimately present in the base mixture, as a result of which the Theological behavior, in particular the flowability and viscosity stability, of the base mixture and that of the crosslinkable silicone rubber compositions produced therefrom is considerably improved.

The in-situ process for producing base mixtures has, inter alia, the disadvantage that the hydrophilic silica can be mixed only a little at a time into the mixture of polyorganosiloxane and hydrophobicizing agent, since the compact composition otherwise disintegrates into a pulverulent mixture which can no longer be processed further. In addition, residues and by-products of the hydrophobicizing agent and also added water have to be removed after the hydrophobicization phase, which ultimately makes time-consuming mixing, kneading and baking, typically over a period of several hours, necessary. The in-situ process is therefore employed predominantly in discontinuously operating mixing apparatuses (batch processes) where sufficiently long residence times are given. For example, the German published specification DE 42 15 205 A1 describes a continuously operating in-situ process for producing silicone rubber compositions, in which the production of the base mixture is made possible by connection of three mixing apparatuses in series at a total residence time of the base mixture of about one hour, but this requires a high outlay in terms of apparatus and process engineering.

Dispersion of a prehydrophobicized silica in polyorganosiloxanes does not have the abovementioned disadvantages of the in-situ process and additionally has the advantage that it can be carried out both in discontinuously operating mixing apparatuses and in continuously operating mixing apparatuses, although only short residence times are available in the latter. Compared to discontinuous processes, continuous processes represent an important technological step forward since significantly higher space-time yields and lower fluctuations in product quality can be achieved. Such a process for the continuous production of base mixtures using pre-hydrophobicized silica is described in the German published specification DE 196 17 606 A1. Dispersion of the prehydrophobicized silica takes place, for example, during a residence time of only 15 minutes.

However, dispersing a prehydrophobicized silica in the polyorganosiloxane in a very short time also has disadvantageous effects. Firstly, the constituents of the mixture are not fully in equilibrium, which can be seen from changes in the viscosity during subsequent storage of the base mixture or of the silicone rubber composition produced therefrom. In general, a continual increase in viscosity occurs during storage despite the use of a prehydrophobicized silica. This phenomenon known as crepe hardening is associated with the formation of polymer bridges between the filler particles. Since the interaction between filler and polyorganosiloxane is reduced as the degree of hydrophobicization of the silica increases, an improvement in the flowability and viscosity stability can, to a certain extent, be achieved by increasing the degree of hydrophobicization of the prehydrophobicized silica. However, the reinforcing action of the silica decreases with increasing degree of hydrophobicization, which, especially at very high degrees of hydrophobicization, has an adverse effect on the mechanical strength and the mechanoelastic property profile of the resulting silicone elastomers.

A series of additives which improve the flowability and viscosity stability of crosslinkable silicone rubber compositions are known from the prior art. The German published specification DE 195 45 365 A1 describes, for example, a process for producing storage-stable silicone rubber compositions, in which silanols or alkanols are added. However, such additives are disadvantageous from many points of view, since they increase the proportion of volatile or extractable constituents, influence the pot life and the crosslinking rate and also lead to odor pollution in the processing of the silicone rubber composition.

It is therefore one object of the present invention to develop a process for dispersing surface-treated finely divided fillers in polyorganosiloxanes, which leads, without addition of reactive additives which remain in the silicone composition, to flowable, viscosity-stable base mixtures and, in particular, crosslinkable silicone rubber compositions.

Dispersing a prehydrophobicized finely divided silica in the polyorganosiloxane in a very short time has a further disadvantage. Finely divided fillers generally have very low bulk densities, i.e. the density of the material is from one to two orders of magnitude lower than the density of the solid present in the material. The amount of gas (air) present in the material for this reason is largely displaced to the outside during mixing of the finely divided filler into the polyorganosiloxane. However, reinforcing, structured fillers such as finely divided silicas have a fractal structure, so that a certain amount of gas unavoidably remains at the surface and in the interior of the filler particles. During mixing and subsequent storage, this particle-bound air is increasingly displaced from the polyorganosiloxane as a result of the latter wetting the filler surface and thus increasingly penetrating into the fractal, porous structure of the filler particles (infiltration). However, there are limits to this process which occurs over hours to days. Owing to the chain length of the polyorganosiloxane used, which results in a particular hydrodynamic radius, and the fractal structure of the finely divided filler, wetting of the filler can never proceed to completion; tiny gas inclusions (air pockets) whose dimensions are in the submicron range always remain on the surface or in the interior of the filler particles. The presence of these air pockets can present problems under particular process conditions of the silicone rubber composition. In the case of liquid silicone rubber compositions to be processed by injection molding, crosslinking occurs within a few minutes at high temperatures, for example in the region of 180° C., and hydrostatic pressures of several hundred bar, which is associated with a rapid pressure drop on opening the mold. This has the consequence that the hot LSR composition present in the injection-molding tool or the molded LSR article which is still hot on opening the injection-molding tool is supersaturated with the volatile constituents dissolved in the LSR composition used, e.g. water, air, short-chain siloxanes, cyclosiloxanes, inhibitors, etc. The abovementioned air pockets can then, if their size exceeds a particular critical value, function as boiling nuclei and lead to formation of larger voids which can be seen with the naked eye, also referred to as “white spots”, in the silicone elastomer component, thus making the latter unusable. Number and size of the air pockets present in silicone rubber compositions depend critically on, inter alia, the dispersion conditions. Thus, long kneading times associated with high shear forces are necessary for the wetting process, since increased breaking up of the fractal structures (aggregates, agglomerates) and thus at the same time better infiltration can occur. It can therefore be assumed that dispersion of prehydrophobicized silicas within very short residence times has disadvantages in this respect.

A further object of the present invention is to provide a process for dispersing surface-treated finely divided fillers in polyorganosiloxanes, which gives crosslinkable silicone rubber compositions which display improved processing behavior, in particular avoid the formation of white spots.

It has now surprisingly been found that the storage stability of crosslinkable silicone rubber compositions, their processing properties and the mechano-elastic properties of the crosslinked shaped articles can be significantly improved if a low molecular weight, unreactive organosilicon compound is added during compounding of the base mixture comprising polyorganosiloxane and filler and is subsequently mostly to completely removed again.

The present invention accordingly provides a process for producing silicone compositions comprising surface-treated, finely divided fillers, wherein
(a) the mixing of a surface-treated, finely divided filler (A) with a polyorganosiloxane (B) is carried out in the presence of a low molecular weight organosilicon compound (C) which has from 2 to 10 silicon atoms and contains no hydrolyzable or condensable functional groups, or
(b) a mixture comprising a surface-treated, finely divided filler (A) and a polyorganosiloxane (B) is homogeneously mixed with a low molecular weight organosilicon compound (C) which has from 2 to 10 silicon atoms and contains no hydrolyzable or condensable functional groups,

and the filler-containing silicone composition is subsequently freed of the low molecular weight organosilicon compound (C) to an extent of at least 80% based on the amount of low molecular weight organosilicon compound (C), with the surface-treated, finely divided filler (A), the polyorganosiloxane (B) and the organosilicon compound (C) each being able to be a single substance or a mixture of substances.

The base mixtures produced by the process of the invention can be processed to form finished, crosslinkable silicone rubber compositions by addition of additives necessary for crosslinking, for example peroxides, crosslinkers, catalysts, inhibitors, photosensitizers and photoinitiators and also further additives such as colored pigments, plasticizers, antistatics, blowing agents. Crosslinking can be effected, for example, by peroxidic initiation, by addition of aliphatically unsaturated groups onto SiH-functional crosslinkers (hydrosilylation) in the presence of noble metal catalysts, by means of a condensation reaction or by radiation-induced crosslinking (UV radiation, X-radiation, alpha-radiation, beta-radiation or gamma-radiation).

An important feature of the invention is that low molecular weight, accordingly usually volatile, unreactive organosilicon compounds make accelerated, more complete wetting and infiltration of finely divided, structured fillers possible, as a result of which the viscosity increase during storage caused by formation of polymer-bridged filler particles is avoided. At the same time, a reduction in the size and number of the air pockets present in structured fillers is associated with the more complete wetting, as a result of which the crosslinkable silicone rubber compositions display improved processing behavior, in particular they do not tend to form white spots or tend to do so to a significantly reduced extent. This is surprising insofar as the low molecular weight, unreactive organosilicon compound (C) which can undergo only adsorptive interactions with the filler does not remain in the silicone composition but is largely to completely, as far as this is technically possible or economically feasible, removed from the silicone composition again. In contrast, the addition of reactive organosilicon compounds, i.e. organosilicon compounds containing hydrolyzable or condensable groups, which can form strong covalent bonds with the groups present on the filler surface, for example hydroxyl groups, is generally associated with a considerable increase in the viscosity of the crosslinkable silicone rubber composition.

Since the mixing process is very different depending on the chemical composition and in particular viscosity of the polyorganosiloxane and the type and amount of filler used, numerous processes and mixing tools have been developed to ensure optimal mixing. Mixing tools which can be used for producing the silicone compositions of the invention comprising surface-treated finely divided fillers are, for example, stirrers, sigma kneaders, punch kneaders, kneading machines as described, for example, in the German patent DE 40 04 823 C1, internal mixers, single-screw extruders, twin-screw extruders, reciprocating kneaders, dissolvers, mixing turbines, press mixers and mixing rollers in a wide variety of designs. The process of the invention is preferably implemented in mixing apparatuses which are suitable for shearing highly viscous materials, for example sigma kneaders, extruders or the kneading machine described in the German patent DE 40 05 823 C1.

Mixing of the filler with the polyorganosiloxane and, if appropriate, further starting materials can be carried out at a temperature of from −40° C. to +300° C. If no thermolabile constituents are mixed in, the mixing process is preferably carried out at an elevated temperature of from 50° C. to 250° C., in particular from 100° C. to 230° C. Owing to the heat of friction, the introduction of the starting materials and the limits to temperature control imposed by the apparatus, a temperature profile is generally established along the mixing section and over time during the course of the mixing process. This temperature profile can have relatively large temperature differences.

Mixing of filler (A) with polyorganosiloxane (B) and, if appropriate, the mixing-in of the organosilicon compound (C) can be carried out at atmospheric pressure, superatmospheric pressure or reduced pressure.

Since, in the process of the invention, either the mixing of the filler (A) into the polyorganosiloxane (B) is carried out in the presence of the low molecular weight organosilicon compound (C) (variant a) or else the low molecular weight organosilicon compound (C) is subsequently mixed into the silicone composition produced from (A) and (B) (variant b) and the low molecular weight organosilicon compound (C) is in both cases only finally removed again to a major extent from the silicone composition, it is necessary to choose pressure and temperature conditions as a function of the boiling behavior of the constituent (C) so that the volatile organosilicon compound (C) remains in the mixture during the dispersion procedure in variant a or after mixing of (C) into the mixture comprising (A) and (B) in variant b and can display the necessary activity. The final removal of the constituent (C) from the silicone composition can be effected by increasing the temperature (baking), if appropriate aided by reduced pressure and/or entrainer gases, with continuing kneading/shearing of the silicone composition or by extraction with a suitable solvent. The low molecular weight organosilicon compound (C) removed from the silicone composition can, in a further preferred embodiment, be fed back into the process of the invention.

In a particularly preferred embodiment of the process of the invention, mixing of filler (A) and polyorganosiloxane (B), in the presence or absence of the low molecular weight organosilicon compound (C), is carried out with only part of the total amount of polyorganosiloxane (B) being mixed with the filler (A) so as to take the mixing process through a very highly viscous phase, as a result of which the distributive and in particular dispersive effectiveness of mixing is significantly improved owing to the high shear forces and the accelerated breakdown of filler agglomerates and aggregates, and the silicone composition is only subsequently diluted with the remainder of the polyorganosiloxane until the desired composition of the silicone composition has been obtained. This particularly preferred embodiment applies both to variant a and variant b of the process of the invention.

In the case of variant a of the process of the invention, it is therefore particularly preferred for the total amount of low molecular weight organosilicon compound (C) together with part of the polyorganosiloxane (B) to be placed in the mixing apparatus in a first step and the total amount of filler (A) to be dispersed therein, if appropriate a little at a time. In a second step, the mixture comprising filler (A), part of the polyorganosiloxane (B) and the low molecular weight organosilicon compound (C) is diluted with the remaining amount of polyorganosiloxane (B). The removal of the low molecular weight organosilicon compound (C) is carried out in the third step. The removal of the low molecular weight organosilicon compound (C) can preferably also be carried out prior to dilution with the remaining amount of polyorganosiloxane (B).

In the case of variant b of the process of the invention, it is therefore particularly preferred for the total amount of filler (A) to be dispersed, if appropriate a little at a time, in part of the polyorganosiloxane (B) in a first step. In the second step, the low molecular weight organosilicon compound (C) is mixed into and homogeneously distributed in the highly viscous silicone composition which is, in the third step, diluted with the remaining amount of polyorganosiloxane (B) and finally freed of the low molecular weight organosilicon compound (C). In this case too, the removal of the low molecular weight organosilicon compound (C) can be carried out prior to dilution with the remaining amount of polyorganosiloxane (B).

Possible fillers (A) are all surface-treated finely divided fillers which are customarily used in silicone compositions and have a specific surface area measured by the BET method of at least 50 m²/g, preferably from 100 to 800 m²/g, particularly preferably from 150 to 400 m²/g.

They are typically silicas, carbon blacks and finely divided oxides, hydroxides, carbonates, sulfates or nitrides of metals such as silicon, aluminum, titanium, zirconium, cerium, zinc, magnesium, calcium, iron and boron.

The fillers used in the process of the invention are preferably pyrogenic silicas, precipitated silicas, silica hydrogels which have been dewatered with retention of the structure, also known as Aerogels, and also carbon blacks, as long as these have a carbon content of from at least 0.01 to not more than 20% by weight, preferably from 0.1 to 10% by weight, particularly preferably from 0.5 to 5% by weight, as a result of a surface treatment. Particular preference is given to pyrogenic silicas.

The carbon content of the surface-treated fillers (A) can be achieved by suitable methods, which are well-known to those skilled in the art, for the surface modification (hydrophobicization) of finely divided fillers. Preferred hydrophobicizing agents are organosilicon compounds which are able to react with the filler surface to form covalent bonds or are lastingly physisorbed on the filler surface.

Preferred hydrophobicizing agents correspond to the general average formula (I) or (II)

R¹₄₋ₓSiAₓ (I)

(R¹₃Si)_{y}B (II),

where
the radicals R¹ are identical or different monovalent, unsubstituted or halogen-substituted hydrocarbon radicals having from 1 to 12 carbon atoms,

A is halogen, —OH, —OR² or —OCOR²,

B is —NR³_{3-y},
the radicals R² are identical or different monovalent hydrocarbon radicals having from 1 to 12 carbon atoms,

R³ is a hydrogen atom or has one of the meanings of R¹,

x is 1, 2 or 3, and

y is 1 or 2.

Further preferred hydrophobicizing agents are organopolysiloxanes, comprising units of the general average formula (III)

R⁴_{z}SiO_{(4-z)/2} (III),

where

the radicals R⁴ are identical or different monovalent, unsubstituted or halogen-substituted hydrocarbon radicals having from 1 to 12 carbon atoms, halogen atoms or hydroxy, —OR² or —OCOR² groups and

z is 1, 2 or 3.

Preferred hydrophobicizing agents include, for example, alkylchlorosilanes such as methyltrichlorosilane, dimethyldichlorosilane, trimethylchlorosilane, octyltrichlorosilane, octadecyltrichlorosilane, octylmethyldichlorosilane, octadecylmethyldichlorosilane, octyldimethylchlorosilane, octadecyldimethylchlorosilane and tert-butyldimethylchlorosilane; alkylalkoxysilanes such as dimethyldimethoxysilane, dimethyldiethoxysilane, trimethylmethoxysilane and trimethylethoxysilane; trimethylsilanol; cyclic diorgano(poly)siloxanes such as octamethylcyclotetrasiloxane, decamethylcyclopentasiloxane; linear diorganopolysiloxanes such as dimethylpolysiloxanes having trimethylsiloxy end groups and dimethylpolysiloxanes having silanol or alkoxy end groups; disilazanes such as hexaalkyldisilazanes, in particular hexamethyldisilazane, divinyltetramethyldisilazane, bis(trifluoropropyl)tetramethyl-disilazane; cyclic dimethylsilazanes such as hexamethylcyclotrisilazane. It is also possible to use mixtures of these hydrophobicizing agents. The hydrophobicization of the filler can be carried out in one or more steps, and in the case of a plurality of hydrophobicization steps, different hydrophobicizing agents can also be used.

The polyorganosiloxanes (B) which are preferably used in HTV, LSR and RTV compositions have the general average formula (IV)

R⁵ₐR⁶_{b}SiO_{(4-a-b)/2} (IV),

where
the radicals R⁵ are identical or different monovalent, unsubstituted or halogen-substituted or heteroatom-containing hydrocarbon radicals which have from 1 to 20 carbon atoms and are free of aliphatically unsaturated groups,

the radicals R⁶ are identical or different monovalent, aliphatically unsaturated, unsubstituted or halogen-substituted or heteroatom-containing hydrocarbon radicals which have from 1 to 10 carbon atoms and can undergo a hydrosilylation reaction,

a is a positive number in the range from 1 to 2.997 and

b is a positive number in the range from 0.003 to 2,

with the proviso that 1.5<(a+b)<3.0 and an average of at least two aliphatically unsaturated radicals are present per molecule.

The viscosity of the polyorganosiloxanes (B) determined at 25° C. is in the range from about 0.1 Pa·s to about 40 000 Pa·s, preferably from 100 mPa·s to 30 000 Pa·s. The particularly preferred viscosity range is from 1 to 30 000 Pa·s. Depending on the type of crosslinkable silicone rubber composition to be produced from the base mixture, different viscosity ranges are particularly preferred. For the compositions known to those skilled in the art as RTV-2 (room temperature vulcanizing), viscosities in the range from 100 to 100 000 mPa·s are particularly preferred; for LSR (liquid silicone rubber) compositions, viscosities in the range from 10 to 5000 Pa·s are particularly preferred; and for HTV (high temperature vulcanizing) compositions, viscosities in the range from 2000 to 40 000 Pa·s are particularly preferred.

Preferred examples of radicals R⁵ are alkyl radicals such as the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl and octadecyl radicals; cycloalkyl radicals such as the cyclopentyl, cyclohexyl, cycloheptyl, norbornyl, adamantylethyl or bornyl radical; aryl or alkaryl radicals such as the phenyl, ethylphenyl, tolyl, xylyl, mesityl or naphthyl radical; aralkyl radicals such as the benzyl, 2-phenylpropyl and/or phenylethyl radical and also halogenated derivatives of the above radicals and/or derivatives functionalized with organic groups, e.g. the 3,3,3-trifluoropropyl, 3-iodopropyl, 3-isocyanatopropyl, aminopropyl, methacryloxymethyl or cyanoethyl radical. R⁵ can also be an OH group. Preferred radicals R⁵ are methyl, phenyl and 3,3,3-trifluoropropyl radicals. A particularly preferred radical R⁵ is the methyl radical.

Preferred examples of radicals R⁶ are alkenyl and/or alkynyl radicals such as the vinyl, allyl, isopropenyl, 3-butenyl, 2,4-pentadienyl, butadienyl, 5-hexenyl, undecenyl, ethynyl, propynyl and hexynyl radicals; cycloalkenyl radicals such as the cyclopentenyl, cyclohexenyl, 3-cyclohexenylethyl, 5-bicycloheptenyl, norbornenyl, 4-cyclooctenyl or cyclooctadienyl radical; alkenylaryl radicals such as the styryl or styrylethyl radical and also halogenated and/or heteroatom-containing derivatives of the above radicals, for example the 2-bromovinyl, 3-bromo-1-propynyl, 1-chloro-2-methylallyl, 2-(chloromethyl)allyl, styryloxy, allyloxypropyl, 1-methoxyvinyl, cyclopentenyloxy, 3-cyclohexenyloxy, acryloyl, acryloyloxy, methacryloyl or methacryloyloxy radical. Preferred radicals R⁶ are the vinyl, allyl and 5-hexenyl radicals. A particularly preferred radical R⁶ is the vinyl radical.

The polyorganosiloxane can be a single polyorganosiloxane or a mixture of different polyorganosiloxanes.

The organosilicon compound (C) containing from 2 to 10 silicon atoms contains no hydrolyzable or condensable functional groups. The organosilicon compound (C) can be a silane such as tetramethylsilane, ethyltrimethylsilane, vinyltrimethylsilane, allyltrimethylsilane, allyltriisopropylsilane, phenyltrimethylsilane, diphenyldimethylsilane, benzyltrimethylsilane, hexamethyldisilane, bis(trimethylsilyl)methane, cyclopentadienyltrimethylsilane, acetyltrimethylsilane, aminopropyltrimethylsilane, 3-aminopropylmethylbis(trimethylsiloxy)silane, bis(phenylethynyl)dimethylsilane or trifluoropropyl-trimethylsilane; a linear, branched or cyclic siloxane such as hexamethyldisiloxane, octamethyltrisiloxane, bis(cyanopropyl)tetramethyldisiloxane, bis(tridecafluoro-1,1,2,2-tetrahydrooctyl)tetramethyldisiloxane, 3-phenylhepta-methyltrisiloxane, 3-(3,3,3-trifluoropropyl)heptamethyl-trisiloxane, (3,3,3-trifluoropropyl)methylcyclotrisiloxane or pentavinylpentamethylcyclopentasiloxane, or other organosilicon compounds such as octavinyl-T8-silsesquioxane.

The organosilicon compound (C) is preferably a linear or cyclic oligosiloxane having from 2 to 10 silicon atoms, preferably hexamethyldisiloxane, octamethyltrisiloxane, 1,3-divinyl-tetramethyldisiloxane, octamethylcyclotetrasiloxane, decamethylcyclopentasiloxane and 1,3,5,7-tetravinyl-1,3,5,7-tetramethylcyclotetrasiloxane, particularly preferably hexamethyldisiloxane.

### EXAMPLES

### Example 1 (Not According to the Invention)

160 g of a vinyldimethylsiloxy-terminated polydimethylsiloxane having a viscosity of 20 000 mPa·s (25° C.) were placed in a kneader and mixed with 30 g of hexamethyldisilazane and 9.5 g of water, subsequently mixed with 110 g of pyrogenic silica having a BET surface area of 300 m²/g which is added a little at a time, heated to 90° C. and subsequently kneaded for one hour. The mixture was then diluted with 120 g of vinyldimethylsiloxy-terminated polydimethylsiloxane having a viscosity of 20 000 mPa·s and volatile constituents were subsequently removed at 150° C. under reduced pressure for one hour.

### Example 2 (Not According to the Invention)

160 g of a vinyldimethylsiloxy-terminated polydimethylsiloxane having a viscosity of 20 000 mPa·s (25° C.) were placed in a kneader and mixed with 120 g of prehydrophobicized pyrogenic silica having a BET surface area of 300 m²/g and a carbon content of 4.1%, heated to 90° C. and subsequently kneaded for one hour. The mixture was then diluted with 120 g of vinyldimethylsiloxy-terminated polydimethylsiloxane having a viscosity of 20 000 mPa·s and volatile constituents were subsequently removed at 150° C. under reduced pressure for one hour.

### Example 3 (Not According to the Invention)

153 g of a vinyldimethylsiloxy-terminated polydimethylsiloxane having a viscosity of 20 000 mPa·s (25° C.) and 7 g of a hydroxydimethylsiloxy-terminated polydimethylsiloxane having a viscosity of 30 mm²/sec and a mean chain length of 10 were placed in a kneader and mixed with 120 g of prehydrophobicized pyrogenic silica having a BET surface area of 300 m²/g and a carbon content of 4.1%, heated to 90° C. and subsequently kneaded for one hour. The mixture was then diluted with 120 g of vinyldimethylsiloxy-terminated polydimethylsiloxane having a viscosity of 20 000 mPa·s and volatile constituents were subsequently removed at 150° C. under reduced pressure for one hour.

### Example 4 (Not According to the Invention)

160 g of a vinyldimethylsiloxy-terminated polydimethylsiloxane having a viscosity of 20 000 mPa·s (25° C.) and 7 g of hexamethyldisiloxane were placed in a kneader and mixed with 120 g of prehydrophobicized pyrogenic silica having a BET surface area of 300 m²/g and a carbon content of 4.1%, heated to 90° C. and subsequently kneaded for one hour. The mixture was then diluted with 120 g of vinyldimethylsiloxy-terminated polydimethylsiloxane having a viscosity of 20 000 mPa·s and subsequently kneaded at 50° C. without reduced pressure for one hour. The residual hexamethyldisiloxane content of the silicone composition was 1.5%.

### Example 5 (According to the Invention)

160 g of a vinyldimethylsiloxy-terminated polydimethylsiloxane having a viscosity of 20 000 mPa·s (25° C.) and 7 g of hexamethyldisiloxane were placed in a kneader and mixed with 120 g of prehydrophobicized pyrogenic silica having a BET surface area of 300 m²/g and a carbon content of 4.1%, heated to 90° C. and subsequently kneaded for one hour. The mixture was then diluted with 120 g of vinyldimethylsiloxy-terminated polydimethylsiloxane having a viscosity of 20 000 mPa·s and volatile constituents were subsequently removed at 150° C. under reduced pressure for one hour. The residual hexamethyldisiloxane content of the silicone composition was 0.02%.

### Example 6 (Not According to the Invention)

160 g of a vinyldimethylsiloxy-terminated polydimethylsiloxane having a viscosity of 20 000 mPa·s (25° C.) and 7 g of decamethylcyclopentasiloxane were placed in a kneader and mixed with 120 g of prehydrophobicized pyrogenic silica having a BET surface area of 300 m²/g and a carbon content of 4.1%, heated to 90° C. and subsequently kneaded for one hour. The mixture was then diluted with 120 g of vinyldimethylsiloxy-terminated polydimethylsiloxane having a viscosity of 20 000 mPa·s and subsequently kneaded at 50° C. without reduced pressure for one hour. The residual decamethylcyclopentasiloxane content of the silicone composition was 1.6%.

### Example 7 (According to the Invention)

160 g of a vinyldimethylsiloxy-terminated polydimethylsiloxane having a viscosity of 20 000 mPa·s (25° C.) and 7 g of decamethylcyclopentasiloxane were placed in a kneader and mixed with 120 g of prehydrophobicized pyrogenic silica having a BET surface area of 300 m²/g and a carbon content of 4.1%, heated to 90° C. and subsequently kneaded for one hour. The mixture was then diluted with 120 g of vinyldimethylsiloxy-terminated polydimethylsiloxane having a viscosity of 20 000 mPa·s and volatile constituents were subsequently removed at 150° C. under reduced pressure for one hour. The residual decamethyl-cyclopentasiloxane content of the silicone composition was 0.04%.

### Example 8 (Not According to the Invention)

80 kg/h of vinyldimethylsiloxy-terminated polydimethylsiloxane having a viscosity of 20 000 mPa·s (25° C.) and 60 kg/h of prehydrophobicized pyrogenic silica having a BET surface area of 300 m²/g and a carbon content of 4.1% were metered into a continuously operating mixing apparatus and compacted at 95° C. Vinyldimethylsiloxy-terminated polydimethylsiloxane having a viscosity of 20 000 mPa·s (25° C.) was subsequently introduced and the mixture was kneaded at a temperature of 90° C. The silicone composition was fed into a degassing vessel. The total residence time of the silicone composition in the kneading machine was about 15 minutes. In the degassing vessel, volatile constituents were removed at 90° C. under reduced pressure.

### Example 9 (According to the Invention)

80 kg/h of vinyldimethylsiloxy-terminated polydimethylsiloxane having a viscosity of 20 000 mPa·s (25° C.), 4 kg/h of hexamethyldisiloxane and 60 kg/h of prehydrophobicized pyrogenic silica having a BET surface area of 300 m²/g and a carbon content of 4.1% were metered into a continuously operating mixing apparatus and compacted at 95° C. Vinyldimethylsiloxy-terminated polydimethylsiloxane having a viscosity of 20 000 mPa·s (25° C.) was subsequently introduced and the mixture was kneaded at a temperature of 90° C. The silicone composition was fed into a degassing vessel. The total residence time of the silicone composition in the kneading machine was about 15 minutes. In the degassing vessel, volatile constituents were removed at 90° C. under reduced pressure. The residual hexamethyldisiloxane content of the silicone composition was 0.03%.

### Example 10 (Not According to the Invention)

280 parts by mass of a vinyldimethylsiloxy-terminated polydimethylsiloxane which had a viscosity of 13 000 Pas at 25° C. (corresponding to a mean molar mass of about 500 000 g/mol) were mixed with 120 parts by mass of a hydrophobic pyrogenic silica having a surface area determined by the BET method of 300 m²/g and a carbon content of 4.1% by weight, which was introduced in portions, at 70° C. in a double-Z kneader for one hour to give a homogeneous base composition. This composition was kneaded and baked at 150° C. in an oil pump vacuum for 3 hours.

### Example 11 (According to the Invention)

280 parts by mass of a vinyldimethylsiloxy-terminated polydimethylsiloxane which had a viscosity of 13 000 Pas at 25° C. (corresponding to a mean molar mass of about 500 000 g/mol) and 7 g of hexamethyldisiloxane were mixed with 120 parts by mass of a hydrophobic pyrogenic silica having a surface area determined by the BET method of 300 m²/g and a carbon content of 4.1% by weight, which was introduced in portions, at 70° C. in a double-Z kneader for one hour to give a homogeneous base composition. This composition was kneaded and baked at 150° C. in an oil pump vacuum for 3 hours. The residual hexamethyldisiloxane content of the silicone composition was 0.03%.

TABLE 1
Influence of low molecular weight organosilicon
compounds in the production of LSR compositions on the storage
stability at 25° C.

| | Low molecular weight, | | | |
|---|---|---|---|---|
| | organosilicon compound | | Viscosity [Pa · s] | |
| | [% by weight]^{#} | | | After 4 |
| | | Residual | | weeks at |
| Example | Addition | content | Initial | 25° C. |
| 1* | — | — | 920 | 1250 |
| 2* | — | — | 1020 | 1390 |
| 3* | 1.8% of ODMS | — | 1150 | 1750 |
| 4* | 1.8% of HDMS | 1.5% of HDMS | 920 | 1210 |
| 5 | 1.8% of HDMS | 0.02% of HDMS | 950 | 930 |
| 6* | 1.8% of DMPS | 1.6% of DMPS | 940 | 1180 |
| 7 | 1.8% of DMPS | 0.04% of DMPS | 930 | 960 |
| 8* | — | — | 930 | 1100 |
| 9 | 1.8% of HDMS | 0.03% of HDMS | 940 | 960 |

*not according to the invention
^{#}based on the total silicone composition
HMDS hexamethyldisiloxane
DMPS decamethylcyclopentasiloxane
ODMS SiOH-terminated oligodimethylsiloxane

It can be seen from Table 1 that the addition of a low molecular weight organosilicon compound during the incorporation of surface-treated silica into polyorganosiloxanes and subsequent removal of the low molecular weight organosilicon compound considerably improves the storage stability of the LSR compositions.

TABLE 2
Influence of low molecular weight organosilicon
compounds in the production of HTV silicone compositions on the
storage stability at 25° C.

| | Low molecular weight, | | | |
|---|---|---|---|---|
| | organosilicon compound | | Viscosity [Pa · s] | |
| | [% by weight]^{#} | | | After 4 |
| | | Residual | | weeks at |
| Example | Addition | content | Initial | 25° C. |
| 10* | — | — | 30 | 33 |
| 11 | 1.8% of HMDS | 0.03% of HMDS | 30 | 30 |

*not according to the invention
^{#}based on the total silicone composition
HMDS hexamethyldisiloxane

It can be seen from Table 2 that the addition of a low molecular weight organosilicon compound during the incorporation of surface-treated silica into polyorganosiloxanes and subsequent removal of the low molecular weight organosilicon compound considerably improves the storage stability of the HTV silicone compositions.

### Example 12 (Not According to the Invention)

6 g of vinyldimethylsiloxy-terminated polydimethylsiloxane having a viscosity of 20 000 mPa·s (25° C.) and 0.19 g of a solution containing a platinum-sym-divinyltetramethyldisiloxane complex and 1% by weight of platinum were added to 110 g of the silicone composition described in Example 1 (A composition). The B composition was produced by mixing 110 g of the silicone composition described in Example 1 with 4.1 g of a copolymer composed of dimethylsiloxy, methylhydrogensiloxy and trimethylsiloxy units and having a viscosity of 300 mPa·s at 25° C. and an SiH content of 0.47% and 0.16 g of ethynylcyclohexanol. The components A and B were mixed in a ratio of 1:1 and the addition-crosslinking silicone composition was subsequently crosslinked in a hydraulic press at a temperature of 165° C. for 5 minutes to give a silicone elastomer film and heat-treated at 200° C. for 4 hours.

### Example 13 (Not According to the Invention)

As a difference from Example 12, the silicone composition produced in Example 2 was used.

### Example 14 (Not According to the Invention)

As a difference from Example 12, the silicone composition produced in Example 3 was used.

### Example 15 (Not According to the Invention)

As a difference from Example 12, the silicone composition produced in Example 4 was used.

### Example 16 (According to the Invention)

As a difference from Example 12, the silicone composition produced in Example 5 was used.

### Example 17 (Not According to the Invention)

As a difference from Example 12, the silicone composition produced in Example 6 was used.

### Example 18 (According to the Invention)

As a difference from Example 12, the silicone composition produced in Example 7 was used.

### Example 19 (Not According to the Invention)

As a difference from Example 12, the silicone composition produced in Example 8 was used.

### Example 20 (According to the Invention)

As a difference from Example 12, the silicone composition produced in Example 9 was used.

### Example 21 (Not According to the Invention)

220 g of the silicone composition described in Example 10 were mixed with 0.20 g of ethynylcyclohexanol, 4.1 g of a copolymer composed of dimethylsiloxy, methylhydrogensiloxy and trimethylsiloxy units and having a viscosity of 300 mPa·s at 25° C. and an SiH content of 0.47% and 3.0 mg of bis(phenylacetylide)cyclooctadieneplatinum(II) suspended in 0.5 g of vinyldimethylsiloxy-terminated polydimethylsiloxane having a viscosity of 100 000 mPa·s (25° C.) at a temperature of 20° C. on a roll mill to give a homogeneous composition. This addition-crosslinking silicone composition was subsequently crosslinked in a hydraulic press at a temperature of 165° C. for 5 minutes to give a silicone elastomer film and heat-treated at 200° C. for 4 hours.

### Example 22 (According to the Invention)

As a difference from Example 21, the silicone composition produced in Example 11 was used.

### Example 23 (Not According to the Invention)

220 g of the silicone composition described in Example 10 were mixed with 0.9 g of bis(2,4-dichlorobenzoyl) peroxide at a temperature of 20° C. on a roll mill to give a homogeneous composition. This peroxidically crosslinking silicone composition was subsequently crosslinked in a hydraulic press at a temperature of 165° C. for 5 minutes to give a silicone elastomer film and heat-treated at 200° C. for 4 hours.

### Example 24 (According to the Invention)

As a difference from Example 23, the silicone composition produced in Example 11 was used.

TABLE 3
Influence of low molecular weight organosilicon
compounds in the production of silicone compositions on the
storage stability at 25° C. of the uncrosslinked LSR A and B
compositions produced therefrom.

| | |
|---|---|
| Viscosity of | Viscosity of |
| A composition | B composition |
| [Pa · s] | [Pa · s] |

| | | after 4 weeks | | after 4 weeks |
|---|---|---|---|---|
| Example | Initial | at 25° C. | Initial | at 25° C. |
| 12* | 710 | 1010 | 740 | 1150 |
| 13* | 720 | 1050 | 710 | 1130 |
| 14* | 860 | 1520 | 920 | 1790 |
| 15* | 720 | 1000 | 750 | 980 |
| 16 | 730 | 740 | 720 | 790 |
| 17* | 750 | 990 | 750 | 920 |
| 18 | 740 | 780 | 720 | 760 |
| 19* | 730 | 980 | 710 | 920 |
| 20 | 760 | 750 | 730 | 760 |

*not according to the invention

It can be seen from Table 3 that the addition of a low molecular weight organosilicon compound during the incorporation of surface-treated silica into polyorganosiloxanes and subsequent removal of the low molecular weight organosilicon compound considerably improves the storage stability of the uncrosslinked LSR A and B compositions produced therefrom.

TABLE 4
Influence of low molecular weight organosilicon
compounds in the production of silicone compositions on the
storage stability at 25° C. of the uncrosslinked HTV
compositions.

Viscosity of the uncrosslinked
silicone composition
[Mooney viscosity, initial value]

| Example | Initial | After 4 weeks at 25° C. |
|---|---|---|
| 21* | 29 | 33 |
| 22 | 29 | 29 |
| 23* | 30 | 32 |
| 24 | 30 | 30 |

It can be seen from Table 4 that the addition of a low molecular weight organosilicon compound during the incorporation of surface-treated silica into polyorganosiloxanes and subsequent removal of the low molecular weight organosilicon compound considerably improves the storage stability of the crosslinkable HTV silicone compositions produced therefrom.

TABLE 5
Influence of low molecular weight organosilicon
compounds in the production of silicone compositions on the
mechanical properties of the silicone elastomers produced
therefrom.

| | | Ultimate | | Tear | |
|---|---|---|---|---|---|
| | | tensile | Elongation | propagation | |
| Exam- | Hardness | strength | at | resistance | Compression |
| ple | [Shore A] | [N/mm²] | break [%] | [N/mm] | set [%] |
| 12* | 39 | 9.5 | 650 | 25 | 15 |
| 13* | 40 | 9.6 | 640 | 25 | 16 |
| 14* | 41 | 9.2 | 600 | 21 | 25 |
| 15* | 40 | 9.7 | 630 | 26 | 15 |
| 16 | 40 | 10.3 | 740 | 31 | 10 |
| 17* | 40 | 9.5 | 650 | 25 | 16 |
| 18 | 40 | 10.6 | 780 | 32 | 9 |
| 19* | 41 | 9.7 | 660 | 26 | 14 |
| 20 | 41 | 10.8 | 730 | 33 | 10 |

*not according to the invention

It can be seen from Table 5 that the addition of a low molecular weight organosilicon compound during the incorporation of surface-treated silica into polyorganosiloxanes and subsequent removal of the low molecular weight organosilicon compound significantly improves the mechanical properties of the silicone elastomers produced therefrom.

TABLE 6
Influence of low molecular weight organosilicon
compounds in the production of silicone compositions on the
mechanical properties of the silicone elastomers produced
therefrom.

| | | Ultimate | Elongation | Tear | |
|---|---|---|---|---|---|
| | | tensile | at | propagation | |
| Exam- | Hardness | strength | break | resistance | Compression |
| ple | [Shore A] | [N/mm²] | [%] | [N/mm] | set [%] |
| 21* | 39 | 11.3 | 1050 | 29 | 12 |
| 22 | 40 | 12.5 | 1120 | 34 | 9 |
| 23* | 40 | 11.1 | 800 | 22 | 20 |
| 24 | 41 | 12.0 | 870 | 26 | 17 |

*not according to the invention

It can be seen from Table 6 that the addition of a low molecular weight organosilicon compound during the incorporation of surface-treated silica into polyorganosiloxanes and subsequent removal of the low molecular weight organosilicon compound significantly improves the mechanical properties of the silicone elastomers produced therefrom.

TABLE 7
Influence of low molecular weight organosilicon
compounds in the production of silicone compositions on the
processing of the uncrosslinked LSR A and B compositions by
injection molding, with the A and B compositions being mixed in
a ratio of 1:1, introduced into a passifier mold and
crosslinked in the passifier tool at 180° C.

| | Defect-free molded | |
|---|---|---|
| Example | articles [%] | Occurrence of white spots |
| 12* | 70 | frequent |
| 13* | 70 | frequent |
| 14* | 50 | very often |
| 15* | 65 | frequent |
| 16 | 100 | none |
| 17* | 75 | frequent |
| 18 | 100 | none |
| 19* | 70 | frequent |
| 20 | 100 | none |

*not according to the invention

It can be seen from Table 7 that the addition of a low molecular weight organosilicon compound during the incorporation of surface-treated silica into polyorganosiloxanes and subsequent removal of the low molecular weight organosilicon compound considerably improves the processing of uncrosslinked LSR compositions by injection molding and prevents the formation of bubbles.

TABLE 8
Influence of low molecular weight organosilicon
compounds in the production of silicone compositions on the
processing of the uncrosslinked, addition-crosslinking HTV
compositions by injection molding, with the uncrosslinked
compositions being introduced into a passifier mold and
crosslinked in the passifier tool at 180° C.

| | Defect-free molded | |
|---|---|---|
| Example | articles [%] | Occurrence of white spots |
| 21* | 80 | frequent |
| 22 | 100 | none |

*not according to the invention

It can be seen from Table 8 that the addition of a low molecular weight organosilicon compound during the incorporation of surface-treated silica into polyorganosiloxanes and subsequent removal of the low molecular weight organosilicon compound considerably improves the processing of the uncrosslinked HTV silicone compositions by injection molding and prevents the formation of bubbles.

TABLE 9
Influence of low molecular weight organosilicon
compounds in the production of silicone compositions on the
processing of the uncrosslinked, peroxidically crosslinking HTV
compositions by extrusion, with the uncrosslinked compositions
being crosslinked at 250° C. to produce tubing

| Example | Occurrence of bubbles |
|---|---|
| 23* | frequent |
| 24 | none |

*not according to the invention

It can be seen from Table 9 that the addition of a low molecular weight organosilicon compound during the incorporation of surface-treated silica into polyorganosiloxanes and subsequent removal of the low molecular weight organosilicon compound considerably improves the processing of the uncrosslinked HTV silicone compositions by extrusion and prevents the formation of bubbles.

The characterization of the silicone elastomer properties was carried out in accordance with DIN 53505 (Shore A), DIN 53504-S1 (ultimate tensile strength and elongation at break), ASTM D (tear propagation resistance) and DIN 53517 (compression set). The viscosity was determined at a shear rate of 0.9 s⁻¹. The Mooney values reported in Tables 2 and 4 are the initial Mooney values (DIN 53523).

1.-11. (canceled)

12. A process for producing silicone compositions containing surface-treated, finely divided fillers, comprising
(a) mixing of a surface-treated, finely divided filler (A) with a polyorganosiloxane (B) in the presence of a low molecular weight organosilicon compound (C) which has from 2 to 10 silicon atoms and contains no hydrolyzable or condensable functional groups, or
(b) mixing a composition comprising a surface-treated finely divided filler (A) and a polyorganosiloxane (B), with a low molecular weight organosilicon compound (C) which has from 2 to 10 silicon atoms and contains no hydrolyzable or condensable functional groups,
and removing the low molecular weight organosilicon compound (C) to an extent of at least 80% based on the amount of low molecular weight organosilicon compound (C) from the filler-containing silicone composition, wherein the surface-treated, finely divided filler (A), the polyorganosiloxane (B) and the organosilicon compound (C) are each a single substance or a plurality of substances.

13. The process of claim 12, wherein a total of from 5 to 150 parts by weight of a surface-treated, finely divided filler (A) are mixed into a mixture of 100 parts by weight of polyorganosiloxane (B) and from 0.01 to 30 parts by weight of organosilicon compound (C) and optionally up to 10 parts by weight of further constituents.

14. The process of claim 12, wherein a total of from 0.01 to 30 parts by weight of an organosilicon compound (C) are mixed into a mixture of 100 parts by weight of polyorganosiloxane (B) and from 5 to 150 parts by weight of a finely divided filler (A) which has been surface-treated in a separate process step.

15. The process of claim 12, wherein the surface-treated, finely divided filler (A) has a carbon content of from at least 0.01 to not more than 20% by weight as a result of the surface treatment.

16. The process of claim 12, wherein the surface-treated, finely divided filler (A) has a carbon content of from 0.1 to 10% by weight as a result of the surface treatment.

17. The process of claim 12, wherein the surface-treated, finely divided filler (A) has a carbon content of from 0.5 to 5% by weight as a result of the surface treatment.

18. The process of claim 12, wherein the filler (A) has a BET specific surface area of at least 50 m²/g.

19. The process of claim 12, wherein the filler (A) has a BET specific surface area of from 100 to 800 m²/g.

20. The process of claim 12, wherein the filler (A) comprises a pyrogenic or precipitated silica.

21. The process of claim 12, wherein the polyorganosiloxane (B) has a degree of polymerization of from 50 to 10,000.

22. The process of claim 12, wherein the organosilicon compound (C) is a linear, branched or cyclic oligosiloxane having from 2 to 10 silicon atoms.

23. The process of claim 12, wherein the organosilicon compound (C) comprises one or more selected from the group consisting of hexamethyldisiloxane, octamethyltrisiloxane, 1,3-divinyltetramethyldisiloxane, octamethylcyclotetrasiloxane, decamethylcyclopentasiloxane, and 1,3,5,7-tetravinyl-1,3,5,7-tetramethylcyclotetrasiloxane.

24. The process of claim 12, wherein the surface-treated, finely divided filler (A) has been treated with one or more hydrophobicizing agents selected from the group consisting of silanes of the formulae (I) and (II)
R¹₄₋ₓSiAₓ (I)
(R¹₃Si)_{y}B (II),
where
the radicals R¹ are identical or different monovalent, unsubstituted or halogen-substituted hydrocarbon radicals having from 1 to 12 carbon atoms,
A is halogen, —OH, —OR² or —OCOR²,
B is —NR³_{3-y},
the radicals R² are identical or different monovalent hydrocarbon radicals having from 1 to 12 carbon atoms,
R³ is a hydrogen atom or has one of the meanings of R¹,
x is 1, 2 or 3, and
y is 1 or 2,
and organopolysiloxanes comprising units of the formula (III)
R⁴_{z}SiO_{(4-z)/2} (III),
where
the radicals R⁴ are identical or different monovalent, unsubstituted or halogen-substituted hydrocarbon radicals having from 1 to 12 carbon atoms, halogen atoms or hydroxy, —OR² or —OCOR² groups, and
z is 1, 2 or 3.

25. The process of claim 12, wherein the polyorganosiloxanes (B) comprise units of the formula (IV)
R⁵ₐR⁶_{b}SiO_{(4-a-b)/2} (IV),
where
the radicals R⁵ are identical or different monovalent, unsubstituted or halogen-substituted or heteroatom-containing hydrocarbon radicals which have from 1 to 20 carbon atoms and are free of aliphatically unsaturated groups,
the radicals R⁶ are identical or different monovalent, aliphatically unsaturated, unsubstituted or halogen-substituted or heteroatom-containing hydrocarbon radicals which have from 1 to 10 carbon atoms and can undergo a hydrosilylation reaction,
a is a positive number in the range from 1 to 2.997 and
b is a positive number in the range from 0.003 to 2,
with the proviso that 1.5<(a+b)<3.0 and an average of at least two aliphatically unsaturated radicals are present per molecule.

26. The process of claim 12, wherein mixing takes place in at least one mixing tool selected from the group consisting of stirrers, sigma kneaders, punch kneaders, kneading machines, internal mixers, single-screw extruders, twin-screw extruders, reciprocating kneaders, dissolvers, mixing turbines, press mixers and mixing rollers.
